(19) United States
(12) Patent Application Publication
(10) Pub. No.: US 2007/0177725 A1
(43) Pub. Date: Aug. 2, 2007

(54) System and method for transmitting and receiving secret information, and wireless local communication device using the same

(75) Inventors: Bae-eun Jung, Seongnam-si (KR); Mi-suk Huh, Suwon-si (KR); Kyung-hee Lee, Yongin-si (KR); Yung-ji Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/315,176

(22) Filed: Dec. 23, 2005

(30) Foreign Application Priority Data
Dec. 31, 2004 (KR) 10-2004-117776

(51) Int. Cl. H04L 9/30

(52) U.S. Cl. 380/30

(57) ABSTRACT

A system and method for transmitting and receiving secret information, a device using the same, and a wireless local communication device. The system for transmitting and receiving secret information includes at least one device to generate a ciphertext using public key information that is received over a location-limited channel; and a wireless local communication device to transmit the public key information to the device over the location-limited channel and to decrypt the ciphertext generated at the device. Thus, the secret information can be securely transmitted and received between devices regardless of reliability of the transmission channel.

### CROSS-REFERENCE TO RELATED APPLICATIONS

This application claims the benefit under 35 U.S.C. § 119 (a) from Korean Patent Application No. 2004-117776 filed on Dec. 31, 2004 in the Korean Intellectual Property Office, the entire disclosure of which is incorporated herein by reference.

### BACKGROUND OF THE INVENTION

1. Field of the Invention

The invention relates generally to a system and method for transmitting and receiving secret information. More particularly, the invention relates to a system and method for securely transmitting and receiving secret information over a location-limited channel.

2. Description of the Related Art

Recently, systems in which one server controls a plurality of devices over a network, such as home network systems, have come into wide use. When transmitting and receiving information over the network through such systems, private information may be accessible to others.

In this regard, information encryption and decryption technology has been suggested. According to the encryption and decryption algorithm, information ready to transmit is encrypted with a key at a transmitting side, and a receiving side decrypts the received information with the key and recovers the original information. The encryption and decryption aims to protect information against review by others.

The encryption and decryption algorithm include a symmetric key algorithm and an asymmetric key algorithm. The symmetric key algorithm provides rapid encryption and decryption, but a cryptography key is liable to be compromised in the key management and the key distribution since an encryption key and a decryption key are the same key.

Typically, the operation time of asymmetric key algorithm is lengthy. Hence, a random secret key is often shared and used by communication entities to encrypt and decrypt information according to the symmetric algorithm.

The secret key can be shared among the communication entities by inputting a same key into a module of the entities by a user in an off-line manner, or by generating the secret key based on the asymmetric key algorithm.

A new scheme has been proposed for the sake of the user's convenience, which transmits and shares a secret key over a location-limited channel with a remote controller located in a vicinity of a controlled device.

In the related art, it is deemed that the location-limited channel, which is the physical contact between the remote controller and the controlled device, is secure against attacks such as eavesdropping. Yet, an audio channel, a radio frequency channel or an Infrared Data Association (IrDA) channel may be vulnerable to attacks from eavesdroppers.

To overcome those disadvantages, an authentication method has been presented in consideration of characteristics of the location-limited channel, that is, the vulnerability to the attacks. This authentication method transmits unconcerned information even when the location-limited channel is subject to eavesdropping, but requires a general network channel to share the secret key.

In more detail, authentication information relating to the public key is transmitted over the location-limited channel of the remote controller, and the controlled device transmits to the remote controller a hash value with respect to the used secret key.

When the communication channel is established, the remote controller transmits the public key, and the controlled device extracts authentication information using the public key and compares the extracted authentication information with the received authentication information. If the two authentication information matches, the controlled device encrypts and transmits its secret key. Next, the remote controller decrypts and recovers the secret key, and authenticates the controlled device with a hash value received via the location-limited channel. Herein, the location-limited channel is used only for the authentication channel.

However, the above method requires a general network channel before sharing the secret key. Initial secret key sharing required for a secured link channel needs to share a key of an upper layer.

In this regard, a method is needed to securely transmit public key information between the remote controller and the controlled device without having to use the general communication channel even when the wireless local communication channel is insecure.

In case that the controlled device intending to share the secret key has the capability to operate the public key, it takes more time for the user to stand by with respect to the operation time. Further, the controlled device in a home network is incapable of operating the public key.

Accordingly, a secret key transmission method using the local communication channel is needed such that a controlled device with low resources and without the capability of the public key operation does not require much time for the operation.

### SUMMARY OF THE INVENTION

The invention has been provided to solve the above-mentioned and other problems and disadvantages occurring in the conventional arrangement, and an aspect of the invention provides a system and method for securely transmitting and receiving secret information over a location-limited channel even when the location-limited channel is insecure due to, for example, the possibility of external eavesdropping.

To achieve the above aspect and/or features of the invention, a system for transmitting and receiving secret information includes at least one device to generate a ciphertext using public key information that is received over a location-limited channel; and a wireless local communication device to transmit the public key information to the device over the location-limited channel and to decrypt the ciphertext generated at the device.

The public key information may contain a public key of the wireless local communication device, a protocol request signal, and device information of the wireless local communication device.

The wireless local communication device may include a public key generation module that extracts large integers p and q with a bit size providing reliable computational complexity of cryptology field and generates a public key based on the following equation:
p=3 mod 4
q=3 mod 4
N=pq
where N denotes a public key of the wireless local communication device.

The device may include a random number generation module to generate a random number; and an encryption module to encrypt the generated random number.

The encryption module may generate an integer with pre-defined pattern using the generated random number and encrypt the generated integer with a particular pattern based on the following equation:
Z=Y² mod N
where Y denotes the integer with particular pattern, N denotes the public key of the wireless local communication device, and Z is the ciphertext.

The wireless local communication device may further include a decryption module that computes the random number from the encrypted integer with the particular pattern.

In accordance with another aspect of the invention, a method for transmitting and receiving secret information between a device and a wireless local communication device over a location-limited channel, include transmitting public key information from the wireless local communication device to the device; generating, at the device, a ciphertext using the public key information and transmitting the generated ciphertext to the wireless local communication device; and decrypting the received ciphertext at the wireless local communication device.

The public key information may contain a public key of the wireless local communication device, a protocol request signal, and device information of the wireless local communication device.

The method may further include extracting, at the wireless local communication device, large integers p and q with a bit size providing security in the view of computation complexity and generating a public key based on the following equation:
p=3 mod 4
q=3 mod 4
N=pq
where N denotes a public key of the wireless local communication device.

The encryption of the secret information may include generating a random number; generating an integer with particular pattern having bits in a preset length using the generated random number; and encrypting the generated integer with particular pattern based on the following equation:
Z=Y² mod N
where Y denotes the integer with particular pattern, N denotes the public key of the wireless local communication device, and Z is the ciphertext.

The decryption of the received ciphertext may compute four square roots, select a preset pattern, and compute the random number from the selected integer with the particular pattern.

The method may further include encrypting secret information using the ciphertext when the wireless local communication device has the secret information to be transmitted to the device.

In accordance with yet another aspect of the invention, a device includes a wireless communication module to receive public key information over a location-limited channel; and an encryption module to generate a ciphertext using the public key information received via the wireless communication module.

A wireless local communication device includes a wireless communication module to transmit public key information over a location-limited channel and receive a ciphertext that is encrypted with the public key information; and a decryption module to decrypts the received ciphertext.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of exemplary embodiments, taken in conjunction with the accompanying drawing figures of which:

FIG. 1 is a conceptual diagram of a general home network system;

FIG. 2 is a block diagram of a wireless local communication device and a device according to an embodiment of the invention;

FIG. 3 is a signal flow diagram between the wireless local communication device and the device as shown in FIG. 2; and

FIG. 4 is a flowchart explaining a method for transmitting and receiving secret information according to an embodiment of the invention.

### DETAILED DESCRIPTION OF THE PREFERRED EMBODIMENTS

Reference will now be made in detail to the embodiments of the invention, examples of which are illustrated in the accompanying drawings, wherein like reference numerals refer to the like elements throughout. The embodiments are described below to explain the invention by referring to the figures.

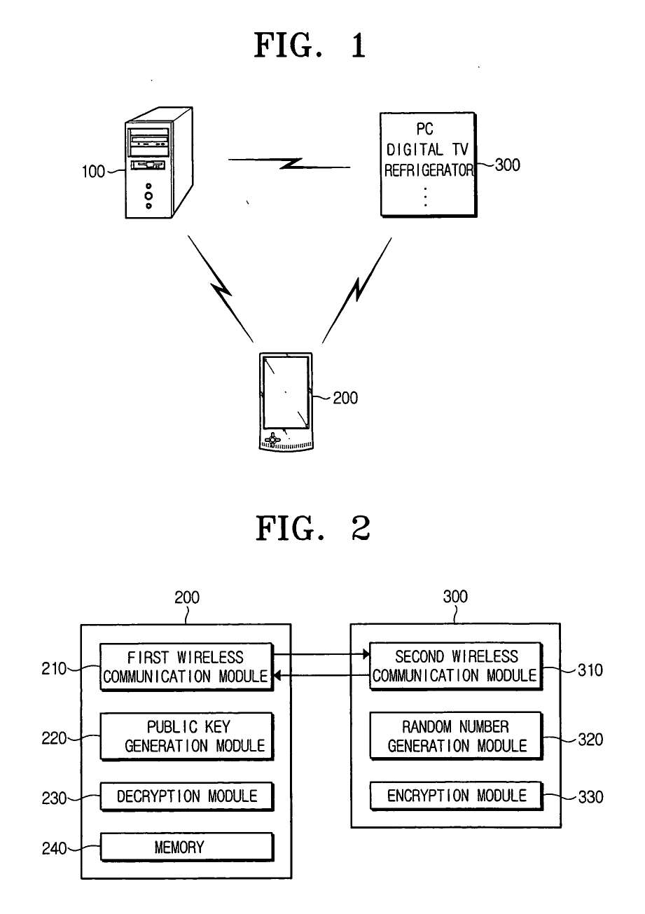

FIG. 1 is a conceptual diagram of a general home network system.

Referring to FIG. 1, the home network system includes a plurality of devices 300, a home server 100, and a wireless local communication device 200. The home server 100 manages and controls the devices 300. The wireless local communication device 200 remotely controls the devices 300 and the home server 100.

The home server 100 responsible to manage and control the devices 300, is authorized to manage and control the devices 300 that are registered through an authentication. The home server 100 includes a gateway, a set-top box, and so forth.

The wireless local communication device 200 transmits public key information to the devices 300 over a location-limited channel and decrypts secret information that is encrypted by the devices 300.

Preferably, the wireless local communication device 200 is a general remote controller capable of wirelessly communicating with the home server 100 and the devices 300. The wireless local communication device 200 may be a wireless terminal that is capable of being mobile, such as mobile phones, personal digital assistants (PDAs), and the like.

The devices 300 have wireless communication means to transmit and receive data and encrypts the secret information using public key information received through the wireless communication means. The devices 300 can be to “next-generation” digital home appliances, such as notebooks, access points (APs), personal computers, digital TVs, and refrigerators, allowing mutual data communication over established wired and wireless networks.

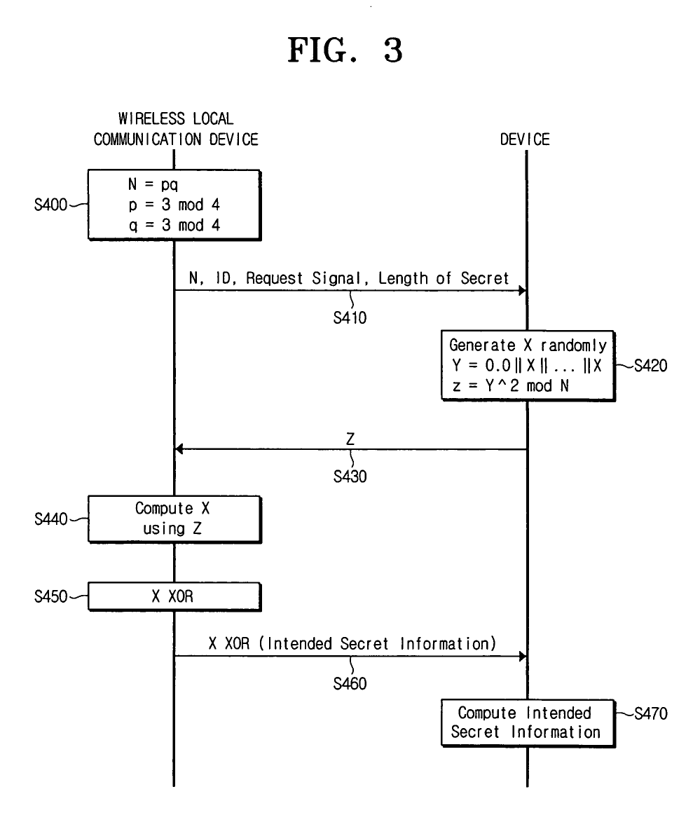

The functions of the wireless local communication device 200 and the devices 300 will be explained in more detail in reference to FIG. 2.

FIG. 1 illustrates the general home network system by way of example. It should be appreciated that the system including the wireless local communication device 200 and the devices 300 may be other wireless local network systems in offices, such as wireless local area networks, or other systems using radio channels, such as Bluetooth.

FIG. 2 is a block diagram of a wireless local communication device and a device according to an embodiment of the invention. Hereinbelow, descriptions are provided of functions of the device 300 used in constructing a system transmitting and receiving secret information according to an embodiment of the invention, and the wireless local communication device 200 in the home network system of FIG. 1.

Referring to FIG. 2, the wireless local communication device 200 includes a first wireless communication module 210, a public key generation module 220, a decryption module 230, and a memory 240.

The first wireless communication module 210 transmits and receives data to and from the device 300 over a location-limited channel. The wireless local communication device 200 transmits public key information and receives a ciphertext via the first wireless communication module 210.

The public key generation module 220 generates a public key pair of the wireless local communication device 200. The public key generation module 220 extracts p and q (secret key), which are integers with a large bit size say (512 bits) providing reliable computational complexity the of cryptology field, and obtains a public key N from the multiplication of p and q. Such computations can be expressed as Equation 1.
p=3 mod 4
q=3 mod 4
N=pq [Equation 1]

The decryption module 230 calculates a random number from the encrypted integer with a particular pattern. Specifically, the decryption module 230 calculates four square roots using the secret key p and q from the encrypted integer with the particular pattern provided from the device 300 over a wireless local communication channel, selects a value corresponding to a preset pattern, and decrypts by calculating the random number from the selected integer with the particular pattern.

The memory 240 stores the secret key p and q and the public key N. In an embodiment of the invention, it is exemplified that the public key N is obtained using the secret key p and q extracted at the public key generation module 220. It is noted that the secret key p and q and the public key N can be provided from outside, rather than generating them in the public key generation module 220. In this case, the memory 240 stores the secret key p and q and the public key provided from outside.

The device 300 includes a second wireless communication module 310, a random number generation module 320, and an encryption module 330.

The second wireless communication module 310 transmits and receives data to and from the wireless local communication device 200 over the location-limited channel. The device 300 receives the public key information and transmits the ciphertext via the second wireless communication module 310.

The random number generation module 320 generates a random number X in a specific length to be transmitted to the wireless local communication device 200.

The encryption module 330 encrypts the random number X generated at the random number generation module 320. According to an embodiment of the invention, the encryption module 330 generates a preset pattern Y with certain bits, for example, an integer with a particular pattern with 1024 bits using the random number X.

For example, assuming that the preset pattern divides 1023 by the bit length of the random number X, pads the remaining bit length by +1 from a least significant bit (LSB) to zero, and generates the random number X up to 1024 bits in the total length, Y can be presented as “0.0||X||. . . ||X” as for the 128-bit random number X.

In addition, the encryption module 330 encrypts with the public key N by squaring an integer with particular pattern N. The encryption of the integer with particular pattern Y can be expressed as Equation 2.
Z=Y² mod N [Equation 2]
In Equation 2, Z denotes the ciphertext.

FIG. 3 is a signal flow diagram between the wireless local communication device 200 and the device 300 as shown in FIG. 2.

The wireless local communication device 200 generates the public key N based on Equation 1 (S400) and transmits the public key information including the generated public key N to the device 300 over the location-limited channel. The public key information may contain the public key N, device information, such as an identification (ID), of the wireless local communication device 200, a protocol request signal, and a length of the public key information to be transmitted (S410).

Upon receiving the public key information from the wireless local communication device 200, the device 300 generates the random number X and the integer with particular pattern Y including the random number X. The device 300 operates the ciphertext Z based on Equation 2 (S420). Next, the device 300 transmits the ciphertext Z to the wireless local communication device 200 (S430).

The wireless local communication device 200 computes the random number X from the received ciphertext Z using the large integers p and q (S440).

If there is intended secret information to be delivered from the wireless local communication device 200 to the device 300, the wireless local communication device 200 encrypts the intended secret information with the ciphertext Z (S450) and transmits the encrypted secret information to the device 300 (S460).

Upon receiving the encrypted secret information (S460), the device 300 computes the secret information (S470).

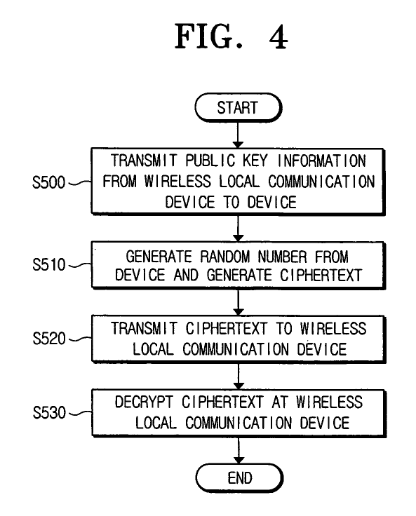

FIG. 4 is a flowchart explaining a method for transmitting and receiving the secret information according to an embodiment of the invention. Hereinafter, the method for transmitting and receiving the secret information is described in reference to FIG. 2 through FIG. 4.

When a user request signal is applied by the user's manipulation of the wireless local communication device 200, the wireless local communication device 200 transmits to the device 300 the public key information including the public key N via the first wireless communication module 210 (S500).

Upon receiving the public key information from the wireless local communication device 200 via the second wireless communication module 310, the device 300 generates the random number X at the random number generation module 320 and generates the ciphertext Z (S510). Next, the device 300 transmits the generated ciphertext to the wireless local communication device 200 via the second wireless communication module 310 (S520).

The wireless local communication device 200, which receives the ciphertext from the device 300 via the first wireless communication module 210, decrypts the ciphertext at the decryption module 230 (S530).

As set forth above, the system and method according to an embodiment of the invention can securely transmit and receive the secret information regardless of the reliability of the transmission channel. The system and method for transmitting and receiving the secret information according to an embodiment of the invention is applicable to a home appliance control system using a mobile terminal such as mobile phones as well as the home network system as illustrated in FIG. 1.

The invention can reduce the overhead generated at a device with low resources and allows the real-time operation since the secret information can be encrypted through the modular multiplication operation alone at the low-resource device such as home appliances.

Furthermore, the secret information required for the device can be easily transmitted by means of the wireless local communication terminal having the remote control function, without having to move the device in the home network system.

Although a few embodiments of the invention have been shown and described, it would be appreciated by those skilled in the art that changes may be made in these embodiments without departing from the principles and spirit of the invention, the scope of which is defined in the claims and their equivalents.

What is claimed is:

1. A system for transmitting and receiving secret information, comprising:
at least one device to generate a ciphertext using public key information that is received over a location-limited channel; and
a wireless local communication device to transmit the public key information to the device over the location-limited channel and to decrypt the ciphertext generated at the device.

2. The system according to claim 1, wherein the public key information contains a public key of the wireless local communication device, a protocol request signal, and device information of the wireless local communication device.

3. The system according to claim 1, wherein the wireless local communication device comprises a public key generation module that extracts large integers p and q with a bit size providing security in the view of the computational complexity and generates a public key based on the following equation:
p=3 mod 4
q=3 mod 4
N=pq
where N denotes a public key of the wireless local communication device.

4. The system according to claim 1, wherein the device comprises:
a random number generation module to generate a random number; and
an encryption module to encrypt the generated random number.

5. The system according to claim 4, wherein the encryption module generates integer with pre-defined pattern using the generated random number and encrypts the generated integer with particular pattern based on the following equation:
Z=Y² mod N
where Y denotes the integer with particular pattern, N denotes the public key of the wireless local communication device, and Z is the ciphertext.

6. The system according to claim 5, wherein the wireless local communication device further comprises a decryption module that computes the random number from the encrypted integer with particular pattern.

7. A method for transmitting and receiving secret information between a device and a wireless local communication device over a location-limited channel, the method comprising:
transmitting public key information from the wireless local communication device to the device;
generating, at the device, a ciphertext using the public key information and transmitting the generated ciphertext to the wireless local communication device; and
decrypting the received ciphertext at the wireless local communication device.

8. The method according to claim 7, wherein the public key information contains a public key of the wireless local communication device, a protocol request signal, and device information of the wireless local communication device.

9. The method according to claim 7, further comprising:
extracting, at the wireless local communication device, large integers p and q with a bit size providing security in the view of the computational complexity and generating a public key based on the following equation:
p=3 mod 4
q=3 mod 4
N=pq
where N denotes a public key of the wireless local communication device.

10. The method according to claim 7, wherein the encryption of the secret information comprises:
generating a random number;
generating an integer with particular pattern having bits in a pre-defined length using the generated random number; and
encrypting the generated integer with particular pattern based on the following equation:
Z=Y² mod N
where Y denotes the integer with particular pattern, N denotes the public key of the wireless local communication device, and Z is the ciphertext.

11. The method according to claim 10, wherein the decryption of the received ciphertext computes four square roots, selects a preset pattern, and computes the random number from the selected integer with particular pattern.

12. The method according to claim 7, further comprising:
encrypting secret information using the ciphertext when the wireless local communication device has the secret information to be transmitted to the device.

13. A device, comprising:
a wireless communication module to receive public key information over a location-limited channel; and
an encryption module to generate a ciphertext using the public key information received via the wireless communication module.

14. The device according to claim 13, wherein the public key information contains a public key of the wireless local communication device, a protocol request signal, and device information of the wireless local communication device.

15. A wireless local communication device, comprising:
a wireless communication module to transmit public key information over a location-limited channel and receive a ciphertext that is encrypted with the public key information; and
a decryption module to decrypts the received ciphertext.

16. The wireless local communication device according to claim 15, wherein the public key information contains a public key of the wireless local communication device, a protocol request signal, and device information of the wireless local communication device.

17. A method of receiving control data, comprising:
generating a cipher text using a public key received over a location-limited channel; and
decrypting encrypted control data received over the channel using the cipher text.

18. A method of sending control data, comprising:
sending a public key over a location-limited channel;
sending, over the channel, the control data encrypted with a received cipher text generated using the public key.

19. A control data transmission method, comprising:
sending a public key over a location-limited channel by a control device;
generating a cipher text by a controlled device using the public key;
sending the cipher text over the channel;
encrypting of the control data by the control device using the cipher text;
sending the encrypted control data over the channel; and
decrypting the control data by the controlled device using the cipher text.

20. The method according to claim 19, wherein the cipher text includes a random number encrypted using the public key and the control data is encrypted with the random number.

21. A control data transmission system, comprising:
a location-limited channel;
a control device sending a public key over the channel; and
a controlled device receiving the public key over the channel, generating a cipher text using the public key and sending the cipher text over the channel, and wherein the control device encrypting of the control data using the cipher text and sending the encrypted control data over the channel, and the controlled device decrypting the control data using the cipher text.
